(19) United States
(12) Patent Application Publication
(10) Pub. No.: US 2008/0230050 A1
(43) Pub. Date: Sep. 25, 2008

(54) Method for the physical treatment of starch (derivatives)

(76) Inventors: Hans-Josef Kersting, Paderborn (DE); Zhengfeng Zhang, Trostberg (DE); Ulrike Funke, Detmold (DE); Lothar Heinrich, Munster (DE); Jurgen Heidlas, Trostberg (DE); Johann Wiesmuller, Garching (DE)

Correspondence Address: FULBRIGHT & JAWORSKI, LLP, 666 FIFTH AVE, NEW YORK, NY, 10103-3198, US

(21) Appl. No.: 12/077,164

(22) Filed: Mar. 17, 2008

Related U.S. Application Data
(63) Continuation of application No. 10/482,320, filed on May 24, 2004, now abandoned.

(30) Foreign Application Priority Data
Jul. 4, 2001 (DE) 101 32 366.2

(51) Int. Cl. C08B 31/00

(52) U.S. Cl. 127/32; 127/71

(57) ABSTRACT

The present invention relates to a method for the physical treatment of starch (derivatives) using densified gases, in which essentially the starting material is treated at process temperatures between 20 and 200° C. and at process pressures between 50 and 800° C. for at least one minute, the density of the densified gas (mixture) being >180 kg/m³. Suitable starting materials are, in particular, native plant starches, starch from genetically modified plants, or physically and/or chemically modified starches. The treatment with, in particular, densified carbon dioxide, can be carried out under defined pressure change sequences, for which, in particular, liquid aids, such as water or suitable organic solvents, can also be added. The starches thus treated have, in particular, advantages in the form of considerably reduced contents, or complete elimination, of accompanying substances, gelatinization enthalpy and gelatinization temperature, and also of the mean particle diameter and can thus be advantageously used in the food, pharmaceutical, chemistry and constructional chemistry and also agrochemical sectors, but also in other fields of application.

This application is a continuation application of U.S. Ser. No. 10/482,320 filed May 24, 2004, which is a §371 of PCT/EP02/07432 filed Jul. 4, 2002, which claimed priority from DE 101 32 366.2 filed Jul. 4, 2001, each of which is incorporated herewith in its entirety.

### BACKGROUND AND SUMMARY OF THE INVENTION

The present invention relates to a method for the physical treatment of starch (derivatives), a starch so treated, and uses thereof.

Starch is a multicomponent system which is made up in a complex manner and which consists of the polymeric parent substances amylose and amylopectin. Amylose and amylopectin are themselves composed of unbranched and branched D-glucose units, that is to say in the case of amylose, of predominantly unbranched chains of glucose molecules which are linked to one another by α-(1,4)-glycosidic bonds. Amylopectin consists of D-glucose units which have α-(1,4)-glycosidic links within the chain and α-(1,6)-glycosidic links at branching points. Together with proteins, and in the case of cereal starches, with lipids, and also with water, these multicomponent systems are associated to form semicrystalline starch granules.

The property profile of starch which, as a plant storage material, occurs particularly abundantly in seeds (cereals) and tubors (potatoes), is highly dependent on their origin and is decisively characterized by the amylose/amylopectin ratio.

Size, shape, morphology and chemical composition of starch and starch granules and also of the complex accompanying materials associated therewith determine the use of starch in the food industry and also in the non-food sector.

The most important functional properties of starches and of their aqueous suspensions and solutions may be considered to be their thickening capacity, the binding and aggregation behaviour.

Thus the molecular weights and particle sizes of starch exhibit a pronounced raw material-specific distribution character and at characteristic temperatures which are likewise raw material-specific, in fluid phases the structural degradation of the starch granules begins. A particular technical importance is ascribed to structural degradation of starch in water with temperature increasing at the same time. This process is generally termed swelling and gelatinization behaviour.

However, the lipid content in some starches also plays a technologically important role. This is because, in addition to their occurrence as inclusion complexes with amylose, the lipids, inter alia as hydrophobic surface-active substances of starch granules, are critical for surface characteristics thereof and affinity thereof and are thus important parameters for the swelling and gelatinization behaviour, the chemical reactivity and selectivity of the starch (granules). The swelling and gelatinization behaviour of the starches is their most important material-specific parameter.

In addition to the abovementioned factor surface characteristics, the swelling and gelatinization behaviour of starches is also critically determined, however, by the structure of the internal surface. Thus, for example, extracted starches have gelatinization properties which differ as a function of the extraction method and conditions used which, in particular is the case after lipid extraction, since in lipid extraction solvents of differing polarities are used.

By using a broad spectrum of mechanical, thermal, chemical and/or biochemical processes, the functional properties of the starches can be varied specifically and thus matched to the respective requirements.

The physical properties of native unmodified starches and of the properties of sols which have been prepared from starch aqueous suspensions by heating limit the use of this group of substances in commercial applications. Taking into account the respective specific technical property profiles, in particular the behaviour of starch granules in or with respect to water, for example regarding the water retention capacity and Theological behaviour is the limiting step in commercial application.

Insolubility, poor swelling capacity in cold water, uncontrolled and uncontrollable viscosity increase on cooking, and also temperature- and/or shear- and also pH-induced viscosity decreases are typical of unmodified starches.

The lack of optical transparency of starch sols, the opaque appearance of gels which develop on cooling and also a deficient freeze-thaw stability are frequently undesirable property profiles.

Modification starches, in particular using physical methods, is thus especially important from the economic aspect.

The use of densified gases as solvents in the food industry has developed markedly in the last 20 years. After in the 1980s principally the extraction of natural substances, for example methods for decaffeination, played a role, the potential use of densified gases in the 1990s shifted clearly to the “material sciences”: thus supercritical gases are now also being used, inter alia, in chemical processes for reducing the viscosity of solutions or for producing ultrafine particles.

On account of its inert properties, toxicological safety, good availability and the physical and physicochemical properties, carbon dioxide plays the most important role when supercritical solvents are concerned in the process technology in general.

Here, the essential motive for using gases in the supercritical state is frequently their markedly lower density compared with “liquid” solvents, the fact that the density in the supercritical state can be controlled continuously in a broad range by varying the process pressure plays a decisive role. The fact that the density of a supercritical gas, put simply, correlates with its dissolving power is an ideal prerequisite for carrying out selective extractions or separations. Thus, in the prior art, many examples of methods are described in which the selectivity of the extraction, in particular in the case of natural substances, plays the decisive role, which justifies the use of supercritical gases from the economic aspect.

On account of the abovementioned properties, gases in the densified (compressed) state can be used not only for the selective extraction of substances, that is to say for separation, however, but also for any other uses, for example impregnation or physical treatment for the morphological modification of matrices, for example for pore formation or expansion or for modification up to breakdown of crystalline clusters.

The use of the high-pressure technique with densified gases for processing starches is, in contrast, little-described, however. In Japanese patent 78-39504, a method is described for impregnating starch granules with a gaseous/liquid mixture of CO₂ or N₂ and ethanol. According to this publication, ethanol-CO₂— starch granules impregnated this way have better preservation properties. However, this treatment took place at 5 atm and thus in the non-near-critical region or not in the region of the densified state of gases.

“Cereal Foods World”, 1998, 43 (7), 522, describes an extraction of lipids from flour using a supercritical fluid. In this method wheat flour was extracted at 100° C. at approximately 700 bar using CO₂ and an entrainer of ethanol. A comparison with the conventional extraction method shows, however, that the amounts extracted and the compositions, that is to say neutral, glycolipids and phospholipids, with both extraction methods leads to similar results.

Another article on the diffusivity and solubility of CO₂ in starch at elevated pressure was published in “Ind. Eng. Chem. Res.”, 1996, 35(12), 4457-4463. The measurements were carried out in a CO₂ system using extruded and gelatinized starch at a pressure=117 bar. It was found that the diffusivity of CO₂ is highly dependent on the pressure, but not on the moisture in the range from 34.5 to 39% by weight.

“Biosci. Biotechn. Biochem”, 1993, 57(10), 1670-1673, publishes a work on the adsorption of supercritical CO₂ to polysaccharide starch. The measurements were carried out using potato and corn starches in the pressure range up to 294 bar.

U.S. Pat. No. 5,977,348, finally, teaches the chemical modification of the polysaccharide starch in densified fluid, which starch is esterified or etherified with various chemical reagents at conditions which are supercritical for CO₂, a high degree of substitution being achievable. At the same time, the polysaccharide is reduced in size from a molar weight of approximately 1.2 million to about 0.3 million.

In summary, a simple method for the physical treatment of starch to improve the functional properties and to improve the application properties is desirable. In particular, the physical parameters, for example pore size, specific surface area, swelling and Theological behaviour of starch(es) are to be modified in this case using densified gases in such a manner that their potential for practical use is markedly increased.

It is an object of the present invention, therefore, to develop a method for the physical treatment of starch (derivatives) using densified gases which leads in particular to an improvement in the use properties of starch (derivatives). The physical treatment is to avoid, but at least decrease, the abovementioned disadvantages of, in particular, native starches and, in particular, lead to enhanced swelling and gelatinization behaviour of the starches. The starch thus modified, in addition, is to have a higher specific surface area, where possible, and enhanced flow properties.

This object was achieved by using an appropriate method in which the starting material is treated at process temperatures between 20° C. and 200° C. and at process pressures between 50 and 800 bar for at least one minute, the density of the densified gas (mixture) being >180 kg/m³.

### BRIEF DESCRIPTION OF THE FIGURES

FIG. 1 is a graph showing viscosity of a function of temperature.

### DETAILED DESCRIPTION

Surprisingly, it has been found that when the method according to the present invention is put into practice, owing to the low viscosity and high diffusivity of densified gases, even the smallest pores of starches can readily be reached and that accompanying substances and other adsorbed substances can be selectively and controllably extracted from the starch matrices. Furthermore, it has been found that the densified gas forced in and the mechanical pressure associated therewith acts to enlarge the internal pores, which causes a significant increase in the specific surface areas. Removing extractable substances, for example lipids in particular, acts additionally with the same effect.

The total of these aspects was not predictable to this extent because of the known lability of the helically structured starch polymer.

Starting materials which can be used are in general all possible starch variants, but native plant starch, preferably from maize, wheat and potatoes, starch from genetically modified plants, for example likewise maize, wheat and potatoes, genetically modified starch, preferably from maize, wheat and potatoes, an already physically and/or chemically modified starch, preferably a starch which has been altered by gelatinization, acidification, oxidation, crosslinking, esterification, etherification or ionic modification, or any mixtures thereof have proved to be particularly advantageous.

Starch (derivatives) which have also been found to be suitable in the context of the present invention are those having a defined water content, preferably having a water content between 5 and 30% by weight.

The treatment time is also to be classified as not very critical. However, not least from economic reasons, a treatment time of 30 to 200 minutes is to be preferred.

The gelatinization process of the aqueous starch suspension is an essentially endothermic process. For the thermodynamic characterization, measurements in the present process were made using a 20% strength aqueous starch suspension. Native starch has an endothermic main peak at a temperature between 50 and 80° C. The temperature corresponding to the main peak is also termed gelatinization temperature. The moisture content of the treated starch is affected by the different treatment conditions, from which there result some large changes with respect to the thermodynamically determined gelatinization temperatures.

The choice of suitable densified gas or suitable densified gas mixtures is a function essentially of the type of starting material, that is to say the respective starch, and the aims to be achieved by the treatment. In principle, therefore, gases may be used whose critical state parameters are within industrially practical limits, gases having proved particularly suitable for the present method being carbon dioxide, propane, butanes, ethane, ethylene, dimethyl ether, nitrogen, sulphur hexafluoride, ammonia, halogenated hydrocarbons, preferably partially fluorinated or perfluorinated hydrocarbons, or any mixtures thereof.

As mentioned above, carbon dioxide, because of its outstanding physical, chemical and toxicological properties, is especially suitable.

In practice, in the present method, a very wide density range of the densified, that is to say near-critical or supercritical, gases or gas mixtures can be utilized. Under aspects essential to the invention, it is above 180 kg/M³, with, however, a range between 400 and 1300 kg/M³ being taken to be preferred. To be able to set these densities by means of the process, the operating pressures vary according to the invention between 50 and 800 bar, pressure ranges between 100 and 500 bar being preferred. The process temperature should be above the critical temperature of the gas used or the gas mixture used and is, in particular, between 31° C. and 180° C.

To achieve still better characteristics of the starches thus treated, the treatment with the densified gases can be carried out under successions of pressure pulsations. These pressure pulsations lead to a density change of the densified gases, in which case the density difference within a single pulsation should be as large as possible. With respect to the density or the pressure, there are in principle no limits for the present method. However, for economic reasons, it is expedient if the pressure difference between the individual pulsations is no greater than ten times the critical pressure of the corresponding gas or gas mixture. Otherwise, the density will experience markedly smaller changes than in the near-critical state range of the gas system.

Preference is also given to a method variant which is carried out under a succession of 1 to 100 pulsations, and particular preference to 5 to 10 pulsations.

However, liquid aids can also be added to the near-critical gas or gas mixtures in the context of this method, chiefly at atmospheric pressure, which aids contribute, in particular, to enlarging the starch pores and enhance the solubility of the starch lipids. Suitable aids of this type are, for example, water or organic solvents, such as short-chain alcohols having, for example, 1-5 carbon atoms, ketones having 3-5 carbon atoms, for example acetone, and esters having 2-7 carbon atoms and/or compounds having surface-active properties or any mixtures thereof, which are used, in particular, in amounts <20% by weight, based on the starch used.

Typically, the inventive method is carried out in an autoclave, and preferably in a batch process. After the autoclave has been charged with the starting material, the system is pressurized with carbon dioxide, for example. The system is kept at the desired pressure and temperature for a defined time period which it is envisaged can vary in the range from 1 minute to several hours. In this period the system is preferably subjected to varying pulses. The starch can then be extracted to remove water and lipids, for example. The system is then literally depressurized and the treated starch is discharged.

In addition to the method just described and variants thereof, the present invention also claims physically treated starch (derivatives) which is (are) producible or obtainable by the inventive method.

Since not least the modification temperature with densified gas plays a very important role in the gelatinization temperature of starches, with, for example, the gelatinization temperature decreasing due to a treatment with supercritical CO₂ at 100° C. by about 5° C., from originally 56° C. to 51° C., whereas it decreases only by one degree unit for a treatment temperature of 50° C., preference is also given in the present invention to starch (derivatives), the gelatinization temperature of which is 2 to 10° C. lower than in the starting material.

The effect of the inventive method on the physicochemical properties, and thus also the functional properties, of the treated starch is particularly clearly shown by the change in the gelatinization enthalpy. As the inventive examples verify, the gelatinization enthalpy of the starches treated with densified gases is reduced by more than 50%, compared with the respective starting material. The lower enthalpy values of the starches thus modified indicate changes in the molecular and/or crystalline order within the starch.

The present invention thus also claims corresponding starch (derivatives) having gelatinization enthalpies which are reduced by more than 30%, and in particular more than 50%, based on the starting material.

The reduction in gelatinization enthalpy is affected by the treatment conditions, for example the temperature, pressure, treatment time, water content and pulsation processes. Thus it is possible, by a targeted starch treatment, to achieve a certain enthalpy value which corresponds to the defined state of order and the energy contents.

States of order and energy contents of starches are reflected directly in the adsorption behaviour and also in their Theological behaviour in liquid phases. Thus, when the inventive method is used, it is found that starches having enthalpy values >10 J/g have a single-stage Theological swelling and gelatinization course and corresponding samples, but having decreased enthalpy values <10 J/g, have a two-stage swelling and gelatinization profile.

The adsorption behaviour of the starches in fluid phases is critically affected by their morphological and structural parameters. The nature of the outer boundary surface and of the inner surface, and also the processes in the microscale determine the application profile of the starches. This property profile of the starches expressed firstly by variety-specific differences (cereal, root, tubor starches), and secondly the physical treatment with densified gases can specifically change the property profile with respect to the internal structural and order parameters, with chemical changes, for example a controllable acidification, also being possible.

The efficiency of the treatment with densified gases is also reflected in a change in the granulometric state, that is to say the particle sizes. Thus, a small increase in the mean diameter is determined via the volume distribution at room temperature. A large difference in the mean diameter becomes visible, in particular, if the starch samples are swollen, for example, before measurement at 45° C. for 3 hours in a mixture of 10% by weight of starch and 90% by weight of water. Not least for this reason, starch (derivatives) are also claimed whose mean particle diameter is more than 5%, and in particular more than 15%, above that of the starting material, the differences not rarely being greater than 30%.

However, the present invention also claims starch (derivatives) whose content of accompanying substances, for example water and/or lipids, is reduced by 30 to 90%, based on the amount of these substances in the starting material.

The inventively treated starches, depending on their respective specific properties, can be used in various fields of application, in which case preference is to be given to food, pharmaceutical, chemistry and building chemistry and also agrochemical sectors. Examples which may be listed are, in particular, the following fields of application:
carrier substances having a special outer and inner surface nature, in particular for the adsorption/encapsulation and targeted release (desorption) of active compounds both in the food and non-food sectors;
coating of active compounds (coating substance) in particular of labile and sensitive active compounds, where, instead of an undefined mass, an essentially homogeneous, free-flowing powder is formed. This includes, for example, detergents and cleaning agents, encapsulation and, in association, the protection of flavourings in the food sector, for example convenience products, and also the encapsulation of medical active compounds;
carrier substances having defined retardation behaviour for active compounds in aqueous and non-aqueous multicomponent systems (controlled release of flavours, controlled release of pharmaceuticals, controlled release in the crop-protection sector);
sorbents, for example for purification/extraction processes;
thickeners;
construction materials and fillers, for example for specific polymeric materials and the tyre industry;
aid for controlling, for example liquid retention of complex multicomponent systems (for example paper coatings), and also in the plastics, composite, adhesive and labelling sectors;
hydrocolloids, emulsifiers (hydro)gels.

The examples below are to illustrate further the advantages of the inventive method and the starch (derivatives) treated therewith.

### EXAMPLES

### Example 1

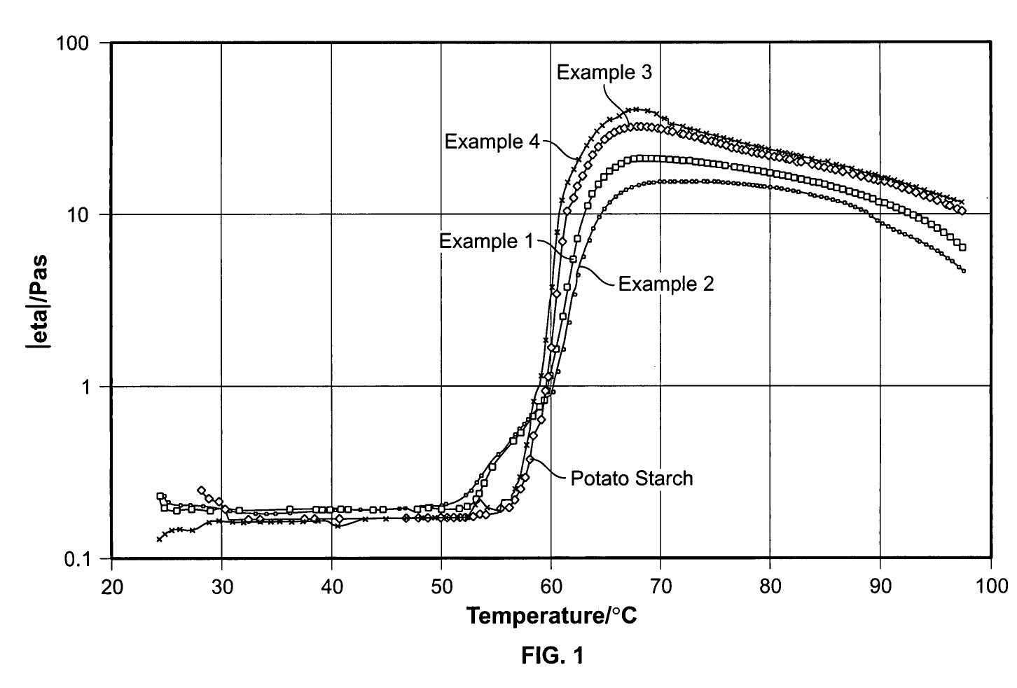

200 g of potato starch were charged into a 1 l autoclave. At a temperature of 100° C., the autoclave was pressurized with CO₂ to 280 bar. Under these conditions the starch was extracted with 4000 g of CO₂. This produced 17 g of extract. The total time was 1 h. The autoclave was then depressurized and the starch was discharged. Table 1 gives the physical properties of this modified potato starch together with the experimental conditions. FIG. 1 shows the relationship between temperature and viscosity of this starch suspension.

### Example 2

200 g of potato starch were charged into a 1 l autoclave. At a temperature of 100° C., the autoclave was pressurized with CO₂ to 280 bar. After 5 min the system was expanded to 150 bar and then repressurized to 280 bar. This pulsation process was repeated a further four times. The total time was 1 h. The autoclave was then expanded to atmospheric pressure and the starch was discharged. Table 1 gives the physical properties of this modified potato starch together with the experimental conditions. FIG. 1 shows the relationship between temperature and viscosity of this starch suspension.

### Example 3

200 g of potato starch were charged into a 1 l autoclave. At a temperature of 100° C. the autoclave was pressurized with CO₂ to 280 bar. The system was kept at these conditions for 1 h. The autoclave was then expanded to atmospheric pressure and the starch was discharged. Table 1 shows the physical properties of this modified potato starch together with the experimental conditions. FIG. 1 shows the relationship between temperature and viscosity of this starch suspension.

### Example 4

200 g of potato starch were charged into a 1 l autoclave. At a temperature of 50° C. the autoclave was pressurized with CO₂ to 280 bar. Under these conditions, the starch was extracted with 4000 g of CO₂. This produced 17 g of extract. The total time was 1 h. The autoclave was then expanded and the starch was discharged. Table 1 shows the physical properties of this modified potato starch together with the experimental conditions. FIG. 1 shows the relationship between temperature and viscosity of this starch suspension.

TABLE 1

| | | Native | | | | |
|---|---|---|---|---|---|---|
| | | starch | Ex. 1 | Ex. 2 | Ex. 3 | Ex. 4 |
| Amount (g) | | — | 200 | 200 | 200 | 200 |
| Temperature (° C.) | | — | 100 | 100 | 100 | 50 |
| Pressure (bar) | | — | 280 | 280/150 | 280 | 280 |
| Pulsation (times) | | — | — | 5 | — | — |
| S/F | | — | 20 | 5 | — | 20 |
| (solvent/feed) | | | | | | |
| Time (min) | | — | 60 | 60 | 60 | 60 |
| Gelatinization | | 55.5 | 51.2 | 52.5 | 50.8 | 54.9 |
| temperature (° C.) | | | | | | |
| Gelatinization | | 25.1 | 10.5 | 7.1 | 7.3 | 14.3 |
| enthalpy (J/g) | | | | | | |
| Viscosity | 50° C. | 0.17 | 0.19 | 0.16 | 0.19 | 0.19 |
| (Pas) | 57° C. | 0.21 | 0.51 | 0.51 | 0.40 | 0.24 |
| | 67° C. | 32.6 | 20.5 | 14.0 | 7.5 | 39.8 |
| | 80° C. | 22.5 | 17.7 | 14.4 | 11.0 | 24.4 |
| Particle | 20° C. | 43 | 45 | 45 | 45 | 45 |
| size | 45° C., | 79 | 81 | 102 | 110 | 105 |
| (μm)* | swollen | | | | | |
| | for 3 h | | | | | |

*Mean diameter derived from the volume distribution

1-23. (canceled)

24. A method for physically modifying starch, comprising treating a mixture consisting of
a) a starch selected from the group consisting of a native plant starch, starch from a genetically modified plant, a physically modified starch, a chemically modified starch and mixtures thereof,
b) a densified gas selected from the group consisting of carbon dioxide, propane, butanes, ethane, ethylene, dimethyl ether, nitrogen, sulfur hexafluoride, ammonia, partially fluorinated hydrocarbons, perfluorinated hydrocarbons and mixtures thereof, and
c) 0 to 20 % by weight of a liquid aid selected from the group consisting of water, an organic solvent, a compound having surface-active properties and mixtures thereof, said organic solvent being selected from the group consisting of alcohols having from 1 to 5 carbon atoms, ketones having from 3 to 5 carbon atoms and esters having from 2 to 7 carbon atoms, for at least one minute at a process temperature between 20 and 200° C. and a process pressure between 50 and 800 bar, wherein the density of the densified gas is greater than 180 kg/m.

25. The method of claim 24, wherein the starch is a native plant starch from maize, wheat or potatoes.

26. The method of claim 24, wherein the starch is from genetically modified maize, wheat or potatoes.

27. The method of claim 24, wherein the starch has a water content between 5 and 30 % by weight.

28. The method of claim 24, wherein the process temperature is from 31 to 180° C.

29. The method of claim 24, wherein the process pressure is between 100 and 500 bar.

30. The method of claim 24, wherein the density of the densified gas is between 400 and 1000 kg/m³.

31. The method of claim 24, wherein the mixture is treated for 30 to 200 minutes.

32. The method of claim 24, wherein the mixture while treated is subjected to a succession of pressure pulsations.

33. The method of claim 32, comprising 1 to 100 pulsations.

34. The method of claim 32, wherein the pressure difference between individual pulsations is no greater than ten times the critical pressure of said densified gas.

35. The method of claim 24, wherein the mixture is treated batchwise.

36. The method of claim 24, wherein the densified gas is carbon dioxide.

37. A native plant starch, physically modified by the method of claim 24, having a gelatinization enthalpy that is more than 30% lower than the gelatinization enthalpy of the non-modified starch.

38. The physically modified starch of claim 37, having a gelatinization enthalpy of less than 10 J/g.

39. A native plant starch, physically modified by the method of claim 24, having a gelatinization temperature that is 2 to 10° C. lower than the gelatinization temperature of the non-modified starch.

40. A native plant starch, physically modified by the method of claim 24, having a mean particle diameter that is more than 5% larger than the mean particle diameter of the non-modified starch.

41. A native plant starch, physically modified by the method of claim 24, having a content of water and lipids that is from 30 to 90% lower than the content of water and lipids of the non-modified starch.

42. The method of claim 25, wherein the densified gas is carbon dioxide.

43. The method of claim 32, wherein the densified gas is carbon dioxide.
